(19) United States
(12) Patent Application Publication
(10) Pub. No.: US 2024/0034459 A1
(43) Pub. Date: Feb. 1, 2024

(54) ELECTROMECHANICAL TRANSMISSION APPARATUS FOR ACTUATION SYSTEMS FOR GUIDANCE SYSTEMS OF AN AIRCRAFT

(71) Applicant: OFFICINE MECCANICHE AERONAUTICHE S.P.A. (IN SIGLA O.M.A. S.P.A.), Foligno (IT)

(72) Inventors: Gennaro FERRARA, Foligno (IT); Pietro ROSATA, Trevi (IT)

(21) Appl. No.: 18/257,465

(22) PCT Filed: Dec. 14, 2021
(86) PCT No.: PCT/IB2021/061703

§ 371 Date: Jun. 14, 2023

(30) Foreign Application Priority Data
Dec. 14, 2020 (IT) 102020000030668

(51) Int. Cl. B64C 13/50; B64C 13/34; F16F 15/121

(52) U.S. Cl. CPC B64C 13/50; B64C 13/34; F16F 15/1217

(57) ABSTRACT

An electromechanical transmission apparatus for actuation systems for guidance systems of an aircraft, includes a planetary gear system configured to provide a kinematic transmission between a driving element and an output shaft. The planetary gear system includes a central sun gear planet gears coupled rotatably to a planet carrier, and an external ring gear; furthermore
having an electromechanical brake and a viscoelastic damper,
the electromechanical brake being configured to lock and release selectively the viscoelastic damper and the central sun gear so that the electromechanical transmission apparatus can be configured:
in an active configuration, and
An electronic control unit is configured to control the electromechanical brake so as to make the transmission apparatus pass from the active configuration to the passive configuration when a locking condition of the driving element occurs.

### CROSS-REFERENCE TO RELATED APPLICATIONS

This application is a 35 U.S.C. § 371 National Stage patent application of PCT/IB2021/061703, filed on 14 Dec. 2021, which claims the benefit of Italian patent application 102020000030668, filed on 14 Dec. 2020, the disclosures of which are incorporated herein by reference in their entirety.

### TECHNICAL FIELD

The present disclosure relates to an actuation system for guidance systems of an aircraft, and particularly to an electromechanical transmission apparatus for this type of systems.

The present disclosure is therefore useful and practical in the field of actuation systems in the aviation sector.

In even greater detail, the present disclosure is particularly but not exclusively useful for interacting with the primary flight controls of an aircraft.

### BACKGROUND

In this specific technical field, and in particular for so-called “All-Electric” aviation, there is a continuous search for electromechanical solutions for “Safety-Critical” actuation, i.e., solutions that guarantee safety even in case of electrical or mechanical failures.

In this field, a particularly relevant technical problem is represented by the reliability of electromechanical devices and of the associated multistage reduction unit.

In fact, mechanical failures (for example seizures) in this type of apparatus have dangerous or even catastrophic effects in aircraft.

Currently, this technical problem is addressed by means of safety devices and mechanical redundancies that have the disadvantage of entailing bulky and expensive architectures.

### SUMMARY

The aim of the present disclosure is to provide an actuation system for guidance systems of an aircraft that solves the technical problem described above, obviates the drawbacks and overcomes the limitations of the background art, being capable of ensuring safety even in case of seizures or other failures (fail-safe/fail-passive design).

Within the scope of this aim, the present disclosure provides an actuation system that has an architecture that is compact and less bulky than that of the background art.

The disclosure also provides an actuation system that is highly reliable.

The disclosure further provides an actuation system that is easy and economical to provide if compared with the background art.

Not least of the disclosure is to provide a valid alternative to the background art.

This aim and these and other advantages that will become better apparent hereinafter are achieved by providing an electromechanical transmission apparatus for actuation systems for guidance systems of an aircraft according to claim 1.

### BRIEF DESCRIPTION OF THE DRAWINGS

Further characteristics and advantages will become better apparent from the description of a preferred but not exclusive embodiment of an electromechanical transmission apparatus and of an actuation system for guidance systems of an aircraft comprising said apparatus, illustrated by way of non-limiting example with the aid of the accompanying drawings, wherein:

FIG. 1 is a schematic view of an actuation system comprising the electromechanical transmission apparatus according to the disclosure;

FIG. 2 is the same view as FIG. 1, in which the kinematic flows during operation in the active configuration, in direct mode, are shown;

FIG. 3 is the same view as FIG. 1, in which the kinematic flows during operation in the active configuration, in inverse mode, are shown;

FIG. 4 is the same view as FIG. 1, in which the kinematic flows during operation in the passive configuration, in the presence of a jamming of the driving element, are shown;

FIG. 5 is an exploded view of a possible embodiment of the planetary gear system comprised in the electromechanical transmission apparatus according to the disclosure;

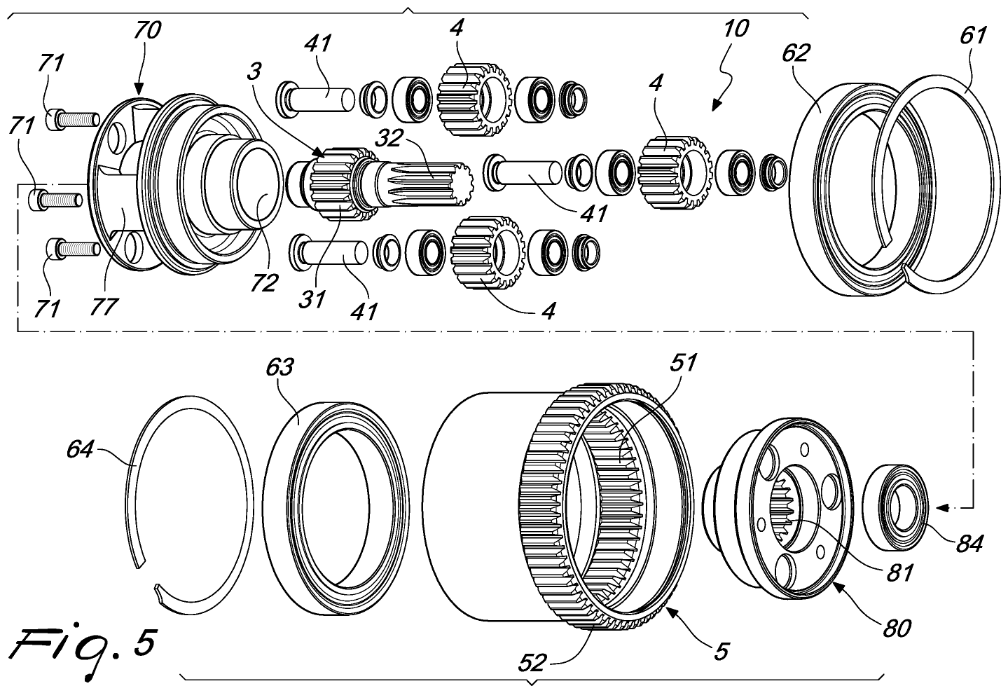

FIG. 6 is a sectional view, taken along a first plane, of the planetary gear system of FIG. 5;

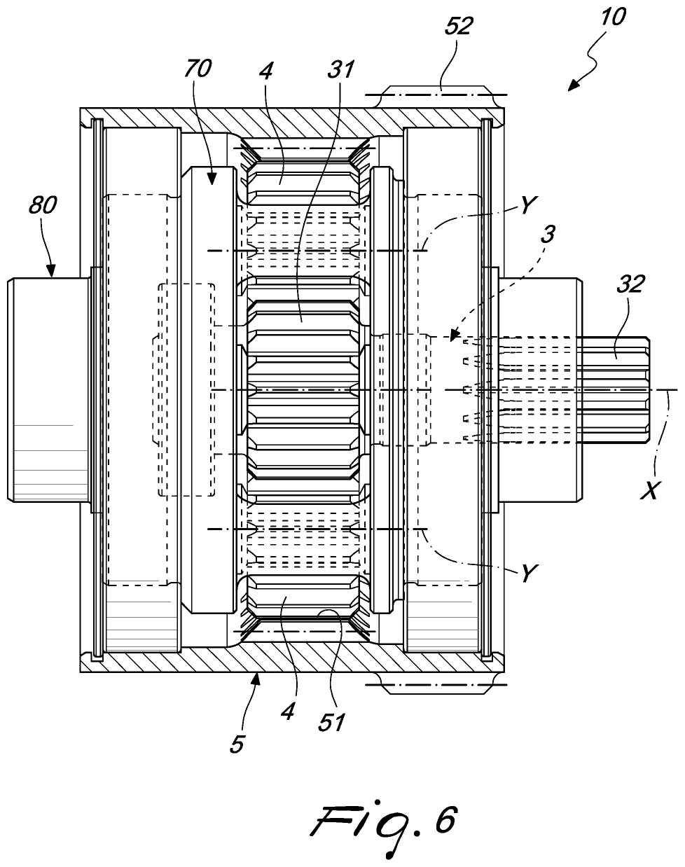

FIG. 7 is a sectional view, taken along a second plane which is parallel to the first plane, of the planetary gear system of FIG. 5; and

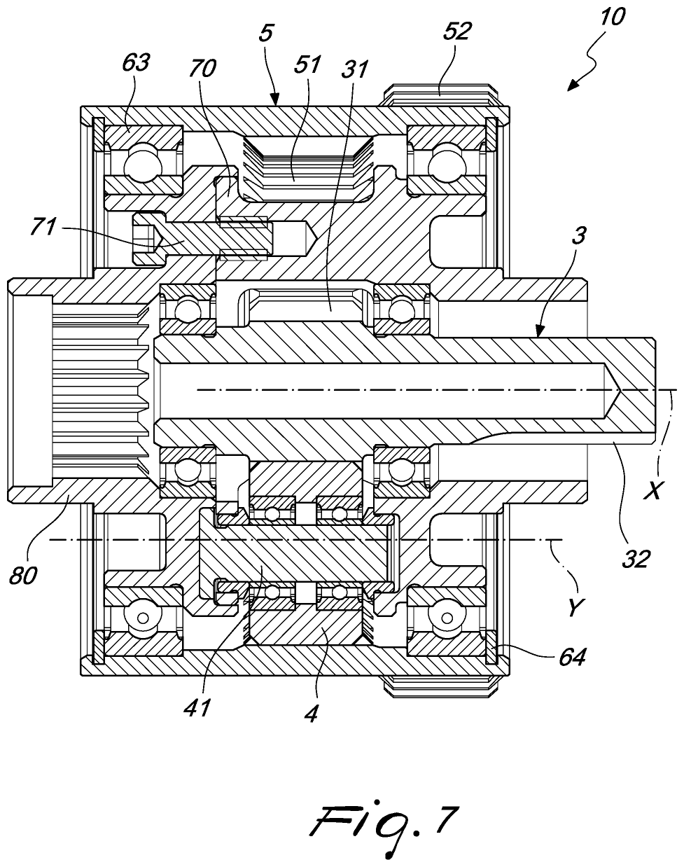

FIG. 8 is a sectional view, taken along a third plane at right angles to the first plane, of the planetary gear system of FIG. 5.

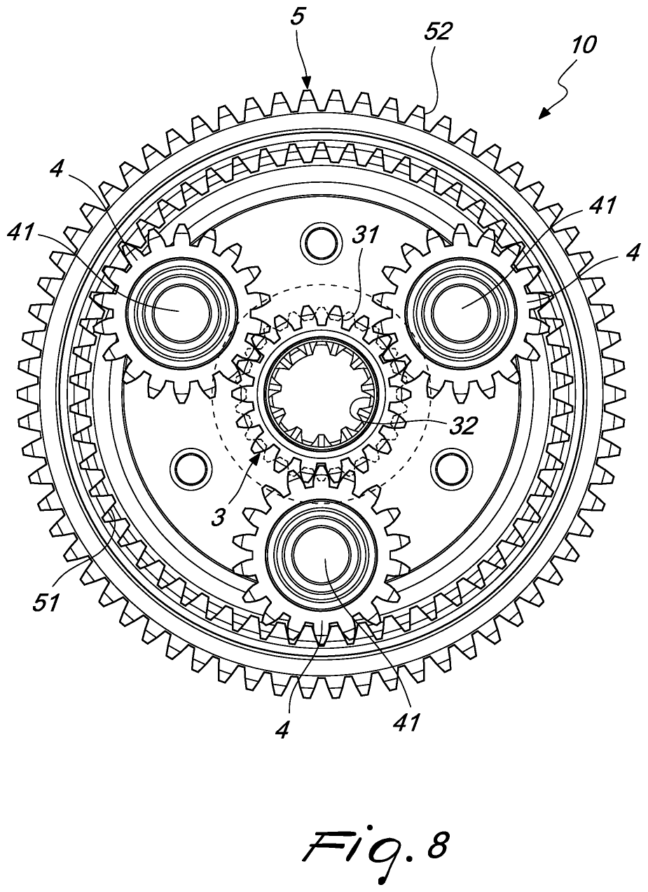

### DETAILED DESCRIPTION OF THE DRAWINGS

With reference to the figures, the electromechanical transmission apparatus for actuation systems for guidance systems of an aircraft is generally designated by the reference numeral 1.

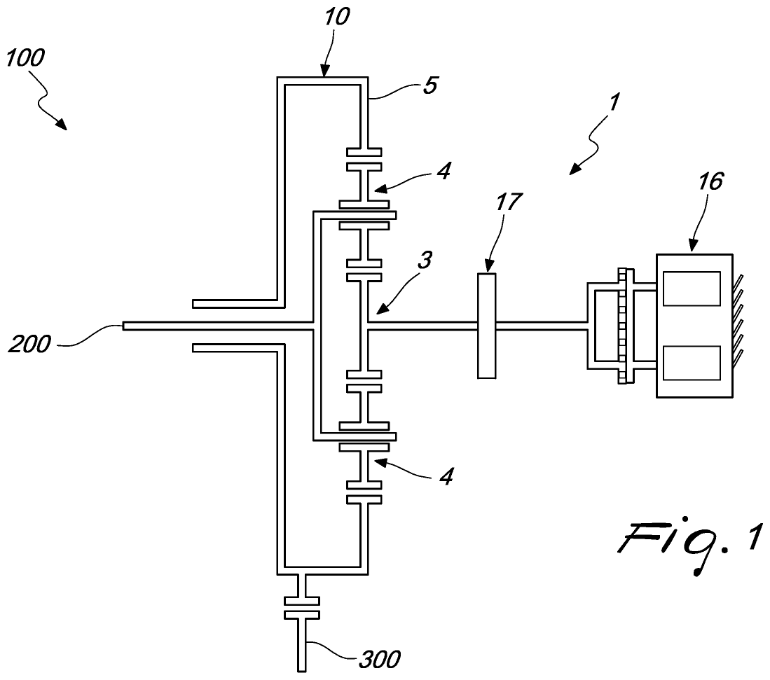

FIG. 1 shows schematically the architecture of the electromechanical transmission apparatus 1 inserted in an actuation system 100 which also comprises a driving element 300 and an output shaft 200, to which the electromechanical transmission apparatus 1 is functionally mechanically connected.

The driving element 300 is in practice a mechanical element which is adapted to transmit motion mechanically and is actuated by an electric motor or other motor; said driving element 300 can comprise for example a gear which is rigidly fixed to a driving shaft which is actuated rotationally by an electric motor.

The electromechanical transmission apparatus 1 comprises a planetary (i.e., epicyclic) gear system (or gear) that is designated by the reference numeral 10.

The planetary gear system 10, as a whole, has a cylindrical geometry, extending around a main central axis X.

The planetary gear system 10 is configured to provide a kinematic transmission between the driving element 300 and the output shaft 200.

In the preferred embodiments, including the one shown, the planetary gear system 10 is configured to provide a speed reduction from the driving element 300 to the output shaft 200, in practice acting as a gearmotor.

As will become better apparent hereinafter, the planetary gear system 10 can be actuated also in an inverse mode, in which it provides a speed multiplication from the output shaft 200 to the driving element 300.

In greater detail, the planetary gear system 10 comprises a central sun gear 3 which can rotate about a main central axis X and a plurality of planet gears 4 which are rotatably coupled to a planet carrier 70 (mounted thereon), i.e., so as to be free to rotate each about its own axis Y, being for example hinged to the planet carrier 70 by means of respective pivots 41.

The planet carrier 70 can in turn rotate about the main central rotation axis X, integrally with the planet gears 4 (i.e., entraining said planet gears 4 in rotation about the central rotation axis X).

Therefore, the planet gears 4 are capable of rotating about their own axis of rotation Y and also of performing, simultaneously, a movement of revolution about the central sun gear 3, meshing therewith and, simultaneously, with the internal set of teeth.

The planet gears 4 are arranged along a circumference and in the preferred and illustrated embodiment are three and mutually equidistant.

Preferably, the planet carrier 70 comprises a carousel body 77 which supports the planet gears 4 and also comprises, or is fixed to, a base 80 provided with a coupling seat 81, which is conveniently provided with a coupling set of teeth for coupling to the output shaft 200.

The base 80 is fixed to the carousel body 77 with appropriate fixing elements 71 (for example screws).

The carousel body 77, which is shaped like a carousel, comprises a central tunnel 72 in which the central sun gear 3 is at least partially accommodated.

The sun gear 3 preferably comprises a shaft end 32 provided with external set of teeth adapted to be optionally engaged by a hub for coupling it rotationally with the sun gear 3.

The planetary gear system 10 comprises furthermore an external ring gear 5, which is provided with an internal set of teeth 51 and an external set of teeth 52.

Said external ring gear 5 also is able to rotate about the main central axis X, has a substantially tubular cylindrical shape and accommodates inside it the planet carrier 70 with the planet gears 4 and the central sun gear 3.

In practice, the planet gears 4 mesh with the central sun gear 3 and also with the internal set of teeth 51 of the external ring gear 5, while the external set of teeth 52 of said external ring gear 5 is adapted to mesh with the driving element 300.

The planet carrier 70, as already mentioned, can be coupled to the output shaft 200 so that a kinematic chain is formed between the driving element 300 and the output shaft 200.

The planetary gear system 10 comprises furthermore all the additional supporting and fixing elements necessary to ensure the operation and the stability of the structure, such as for example fixing rings 61, 64, bearings 62, 63, etcetera, which can be selected by the person skilled in the art according to the requirements and the state of the art.

According to the disclosure, the electromechanical transmission apparatus 1 comprises an electromechanical brake 16 and a viscoelastic damper 17, which are functionally connected to each other and functionally connected to the central sun gear 3.

The viscoelastic damper 17 is a device that, in a known manner, dissipates energy through frictions and/or deformations of passive components that may include mechanical springs, dampers, polymeric or glass-like materials that dissipate energy as a result of tangential deformations.

The viscoelastic damper 17 is functionally connected to the central sun gear 3 so as to dissipate its kinetic energy of rotation.

In the preferred embodiment, the central sun gear 3 comprises a first toothed portion 31 which meshes with the planet gears 4 and a second longitudinally extended portion 32 which protrudes outside the external ring gear 5 and is connected to the viscoelastic damper 17. This longitudinally extended portion 32 also is preferably provided with a set of teeth.

According to the disclosure, the electromechanical brake 16 is configured to lock and release selectively the viscoelastic damper 17 and the central sun gear 3 so that the electromechanical transmission apparatus 1 can be configured in an active configuration and in a passive configuration depending on whether the electromechanical brake locks or releases the viscoelastic damper 17 and the central sun gear 3, respectively.

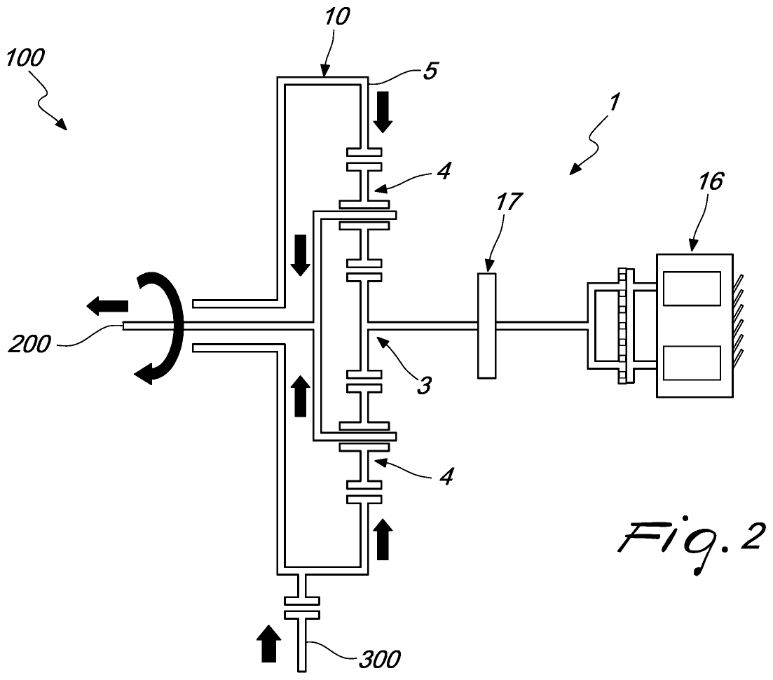

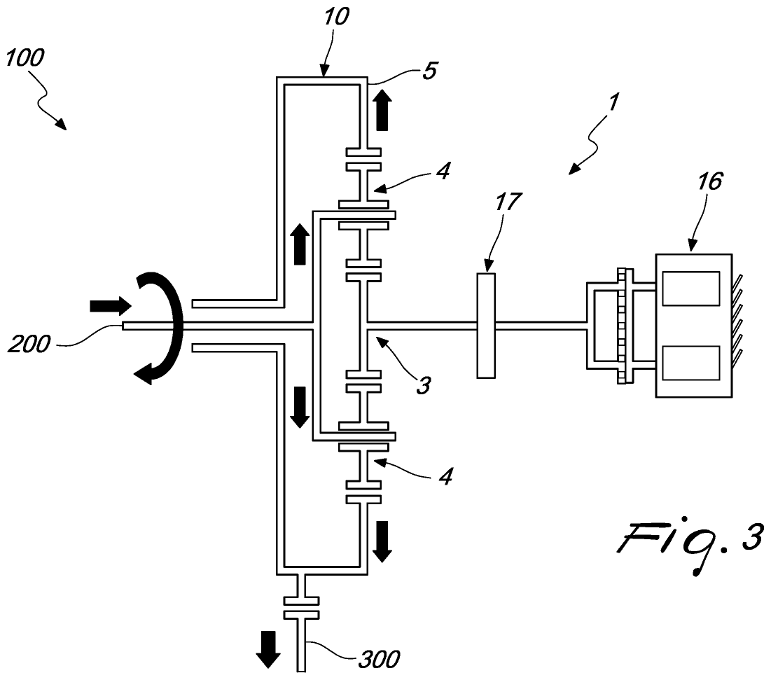

In the active configuration, the viscoelastic damper 17 and the central sun gear 3 are locked by the electromechanical brake 16 and the planetary gear system 10 is consequently able to transmit the motion from the driving element 300 to the output shaft 200 in order to reduce the rotation rate, by means of the rotation of the external ring gear 5 which induces the rotation of the planet carrier 70, as shown in FIG. 2, or vice versa (i.e., transmit the motion from the output shaft to the driving element 300 through the reverse path, so as to multiply the rotation rate, as shown in FIG. 3).

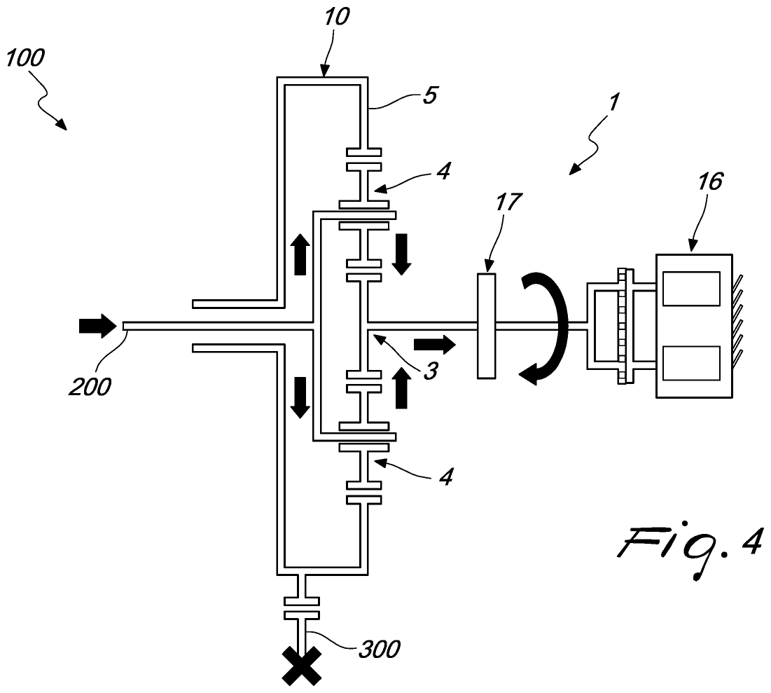

In the passive configuration, the electromechanical brake 16 releases (i.e., frees) the viscoelastic damper 17 and the central sun gear 3 so that the latter is free to rotate so that a rotation of the output shaft 200 induces the rotation of the planet gears 4, which in turn induces the rotation of the central sun gear 3, which is damped by the viscoelastic damper 17 (this occurs for example when the external ring gear 5 is locked by a locking situation of the driving element 300, as shown in FIG. 4).

According to the disclosure, the electromechanical transmission apparatus 1 also comprises an electronic control unit (not shown) configured to control the electromechanical brake 16 so as to let pass the transmission apparatus 1 from the active configuration to the passive configuration when a blocking condition of the driving element 300 occurs which blocks the external ring gear 5.

The transition from the active configuration to the passive configuration can occur advantageously for example in case of a failure or seizure in the electrical or mechanical section of the motor connected to the driving element 300 which is no longer able to rotate and consequently, in the active configuration, the output shaft 200 also would be locked.

In the passive configuration, the viscoelastic damper 17 allows a gentle and damped rotation of the output shaft 200 and of the planet carrier 70, preventing a floating behavior beyond the reversibility friction torque.

The electronic control unit can be configured to monitor the operation of the driving element 300 to intervene, for example, when it is blocked, by activating the electromechanical brake 16, and also to perform the reverse operation by deactivating the mechanical brake 16.

The transition from the active configuration to the passive configuration, and vice versa, is therefore fully reversible and can be repeated according to the requirements.

In the actuation system 100, the electronic control unit also controls the motor that actuates the driving element as a function of the inputs of the pilot.

In the actuation system 100 shown, the electromechanical transmission apparatus 1 is mechanically connected to the driving element 300 (which is actuated by a motor) and to the output shaft 200 so as to transmit the motion from the driving element 300 to the output shaft 200, and more precisely the driving element 300 meshes with the external set of teeth 52 of the external ring gear 5 and the output shaft 200 is rotationally coupled to the planet carrier 70. However, in other embodiments each element of the planetary gear system 10 can be used as input, output or fixed element, and for each configuration it is possible to obtain a different reduction ratio between the input side and the output side.

The operation of the electromechanical transmission apparatus 1 and of the actuation system 100 as a whole is clear and evident from what has been described.

During operation in an aircraft, in a preferred constructive application, the active configuration is the predefined mode of operation in which the actuation system 100:
generates a force-feedback sensation to the pilot under the control of the electronic control unit, by means of the actuation of the motor and of he planetary gear system 10 connected thereto, and therefore to the output shaft 200, in response to the force inputs of the pilot;
generates a mechanical movement of the output shaft 200 in response to a remote request, for example by a Flight Control Computer (FCC), by means of the actuation of the motor and of the planetary gear system 10 connected thereto.

The passive configuration is the mode of operation in which the actuation system 100 does not generate active kinetic energy of rotation but provides a feeling of resistance through the use of passive components such as mechanical springs, frictions and dampers, and in particular the viscoelastic damper 17, bypassing the potential failures of the mechanical part.

Essentially, the described solution provides a differential epicyclic reduction unit with dual load path capable of:
providing the necessary mechanical reduction in normal operating mode,
providing a switchable load path in the event of mechanical seizure, preventing jamming of the output shaft 200 of the actuation system and maintaining a consistent behavior.

In practice it has been found that the electromechanical transmission apparatus and the actuation system, according to the present disclosure, achieve the intended aim and advantages, since they have a compact and less bulky architecture than the background art.

Another advantage of the electromechanical transmission apparatus and of the actuation system according to the disclosure is that they ensure safety even in the event of seizures or other failures.

An additional advantage of the electromechanical transmission apparatus and of the actuation system, according to the disclosure, resides in that they are easy and economical to provide if compared with the background art.

Another advantage of the electromechanical transmission apparatus and of the actuation system, according to the disclosure, is that they are highly reliable.

The electromechanical transmission apparatus and the actuation system thus conceived are susceptible of numerous modifications and variations, all of which are within the scope of the accompanying claims.

All the details may furthermore be replaced with other technically equivalent elements.

In practice, the materials used, as well as the contingent shapes and dimensions, may be any according to the requirements and the state of the art.

1-10. (canceled)

11. An electromechanical transmission apparatus for actuation systems for guidance systems of an aircraft, comprising a planetary gear system configured to provide a kinematic transmission between a driving element and an output shaft;
wherein said planetary gear system comprises: a central sun gear which can rotate about a main central rotation axis, a plurality of planet gears coupled rotatably to a planet carrier which in turn can rotate about the main central rotation axis, and an external ring gear provided with an internal set of teeth and with an external set of teeth; said planet gears meshing with the central sun gear and with said internal set of teeth of the external ring gear, said external set of teeth being adapted to mesh with the driving element, said planet carrier being associable with the output shaft,
and further comprising:
an electromechanical brake and a viscoelastic damper which are functionally connected to each other and functionally connected to said central sun gear,
said electromechanical brake being configured to lock and release selectively the viscoelastic damper and the central sun gear so that said electromechanical transmission apparatus can be configured:
in an active configuration, in which the viscoelastic damper and the central sun gear are locked by the electromechanical brake and the planetary gear system is able to transmit motion from the driving element to the output shaft by means of a rotation of the external ring gear which induces a rotation of the planet carrier, or vice versa, and
in a passive configuration, in which the electromechanical brake releases the viscoelastic damper and the central sun gear so that the central sun gear is free to rotate so that a rotation of the output shaft induces a rotation of the planet gears, which in turn induces a rotation of the central sun gear, which is damped by the viscoelastic damper; and
an electronic control unit configured to control the electromechanical brake so as to make the transmission apparatus pass from said active configuration to said passive configuration when a locking condition of the driving element occurs.

12. The electromechanical transmission apparatus according to claim 10, wherein said planet gears are mounted so that said planet gears are hinged on said planet carrier so as to rotate about an axis of rotation thereof and rotate integrally about the central rotation axis with said planet carrier.

13. The electromechanical transmission apparatus according to claim 11, wherein said planetary gear system is configured to provide a speed reduction from said driving element to said output shaft, or a speed multiplication from said output shaft to said driving element.

14. The electromechanical transmission apparatus according to claim 11, wherein said planet gears are three.

15. The electromechanical transmission apparatus according to claim 11, wherein said planet carrier comprises a carousel body which supports said planet gears and also comprises, or is fixed to, a base provided with a coupling seat for coupling to the output shaft.

16. The electromechanical transmission apparatus according to claim 11, wherein said central sun gear comprises a first toothed portion which meshes with the planet gears and a second longitudinally extended portion which protrudes outside the external ring gear and is connected to the viscoelastic damper.

17. An actuation system for guidance systems of an aircraft, comprising:
a driving element actuated by a motor;
an output shaft which is or can be coupled to a device of the helicopter to drive it;
an electromechanical transmission apparatus according to claim 11, which is mechanically connected to said driving element and to said output shaft so as to transmit the motion from the driving element to the output shaft or vice versa.

18. The actuation system according to claim 17, wherein said driving element meshes with the external set of teeth of said external ring gear and said output shaft is rotationally coupled to said planet carrier.

19. The actuation system according to claim 17, wherein said electronic control unit is configured to monitor the operation of the driving element and to induce a transition to said passive configuration when the electronic control unit detects a locking situation, actuating said electromechanical brake.

20. The actuation system according to claim 17, wherein said electromechanical transmission apparatus, when in the active configuration, can be actuated in an inverse mode, in which the viscoelastic damper and the central sun gear are locked by the electromechanical brake and a rotation imparted to the output shaft is transmitted to the driving element by means of the planetary gear system, in which the rotation of the output shaft induces a rotation of the planet carrier and therefore a rotation of the planet gears, which in turn induces a rotation of the external ring gear, which induces a rotation of the driving element.
